(19) United States
(12) Patent Application Publication
(10) Pub. No.: US 2021/0254743 A1
(43) Pub. Date: Aug. 19, 2021

(54) EXTERNAL ENGAGEMENT STRUCTURE OF HOUSING FOR WATER CONTROL VALVE

(71) Applicant: CHUAN WEI METAL CO., LTD., CHANGHUA COUNTY (TW)

(72) Inventor: Chi-Chuan CHEN, CHANGHUA COUNTY (TW)

(21) Appl. No.: 16/795,276

(22) Filed: Feb. 19, 2020

(51) Int. Cl. F16K 27/12

(52) U.S. Cl. CPC F16K 27/12

(57) ABSTRACT

An external engagement structure of a housing for a water control valve which includes the housing and a valve assembly, and the housing contains: a holder and a cover. The holder is configured to accommodate the valve assembly, and the cover is covered on the holder. The cover includes two opposite retainers formed in an arc shape, two first abutting portions formed on two first sides of the two opposite retainers respectively, and two second abutting portions formed on two second sides of the two opposite retainers respectively, and two rectangular notches. A respective one rectangular notch is defined between a respective one first abutting portion and a respective one second abutting portion of a respective one retainer. The holder includes two opposite arcuate grooves corresponding to the two opposite retainers respectively, two locking protrusions, and two tilted guide faces engaged into the two rectangular notches respectively.

### FIELD OF THE INVENTION

The present invention relates to an external engagement structure of a housing for a water control valve which is applied to avoid a removal of the cover by ways of the two opposite retainers of the cover and the two opposite arcuate grooves of the holder, thus fixing the holder, the cover, and the valve assembly tightly.

### BACKGROUND OF THE INVENTION

A conventional water control valve contains a valve assembly which has a water distribution sheet, an inlet valve disc, an outlet valve disc, a ball valve element, a fixing bolt, and an operation lever, the valve assembly is accommodated in a housing for the water control valve so that the water control valve is connected inside water supply equipment.

The water control valve is packed in a transparent package case so as to be replaceable easily after the water supply equipment is broken.

Referring to FIGS. 1-3, a housing for the water control valve contains: a holder 10 and a cover 20.

The holder 10 is configured to accommodate a valve assembly 30.

The cover 20 includes two opposite retainers 21, two contacting tabs 22 extending from the two opposite retainers 21 respectively, two arcuate engagement portions 23 formed on two bottoms of the two opposite retainers 21 respectively, and two notches 24 defined on the two opposite retainers 21 respectively.

The holder 10 includes two opposite recesses 11 defined on two outer walls thereof respectively and corresponding to the two opposite retainers 21 respectively, and the holder 10 includes the two locking ribs 12 arranged in the two opposite recesses 11 respectively, wherein a size of a respective one locking rib 12 correspond to a size of a respective one notch 24.

The valve assembly 30 is accommodated in the holder 10, and the cover 20 is covered on the holder 10 so that the two opposite retainers 21 are engaged in the two opposite recesses 11 of the holder 10 respectively, and the two notches 24 of the two opposite retainers 21 are retained with the two locking ribs 12 of the two opposite recesses 11 respectively, thus fixing the valve assembly 30, the holder 10, and the cover 20.

However, the two opposite retainers of the cover respectively remove from the two locking ribs of the holder easily when shipping the water control valve, thus causing damage of the water control valve.

The present invention has arisen to mitigate and/or obviate the afore-described disadvantages.

### SUMMARY OF THE INVENTION

The primary aspect of the present invention is to provide an external engagement structure of a housing for a water control valve which contains the two rectangular notches of the two opposite retainers retained with the two locking protrusions of the two opposite arcuate grooves respectively, two first abutting portions formed on two first sides of the two opposite retainers respectively, and two second abutting portions formed on two second sides of the two opposite retainers respectively, such that when the cover is covered on the holder, the two first abutting portions and the two second abutting portions of the two opposite retainers contact with the two opposite arcuate grooves of the holder matingly, and the two rectangular notches of the two opposite retainers are retained with the two locking protrusions of the two opposite arcuate grooves respectively, thus fixing the cover and the holder.

Another aspect of the present invention is to provide an external engagement structure of a housing for a water control valve which is applied to avoid a removal of the cover by ways of the two opposite retainers of the cover and the two opposite arcuate grooves of the holder, thus fixing the holder, the cover, and the valve assembly tightly.

### BRIEF DESCRIPTION OF THE DRAWINGS

FIG. 1 is a perspective view showing the exploded components of a conventional water control valve.

FIG. 2 is a perspective view showing the assembly of the conventional water control valve.

FIG. 3 is a side plan view showing the assembly of the conventional water control valve.

FIG. 4 is a perspective view showing the exploded components of an external engagement structure of a housing for a water control valve according to a preferred embodiment of the present invention.

FIG. 5 is a perspective view showing the assembly of the external engagement structure of the housing for the water control valve according to the preferred embodiment of the present invention.

FIG. 6 is a side plan view showing the assembly of the external engagement structure of the housing for the water control valve according to the preferred embodiment of the present invention.

FIG. 7 is a cross sectional view showing the assembly of the external engagement structure of the housing for the water control valve according to the preferred embodiment of the present invention.

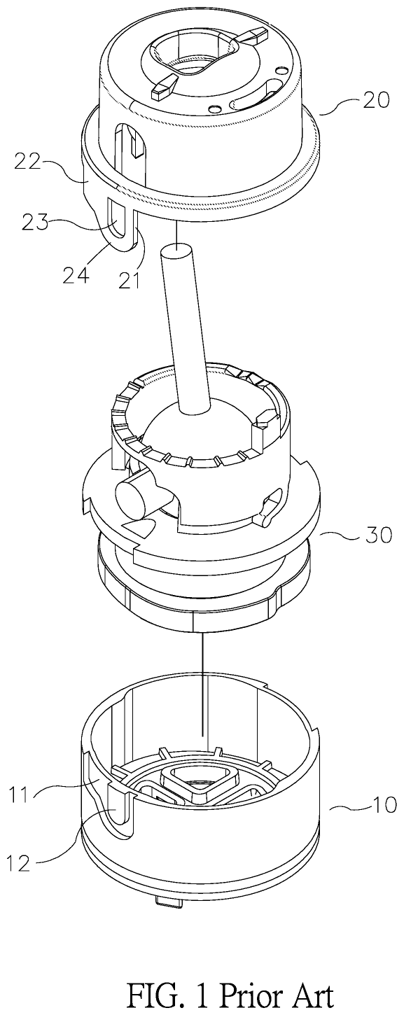

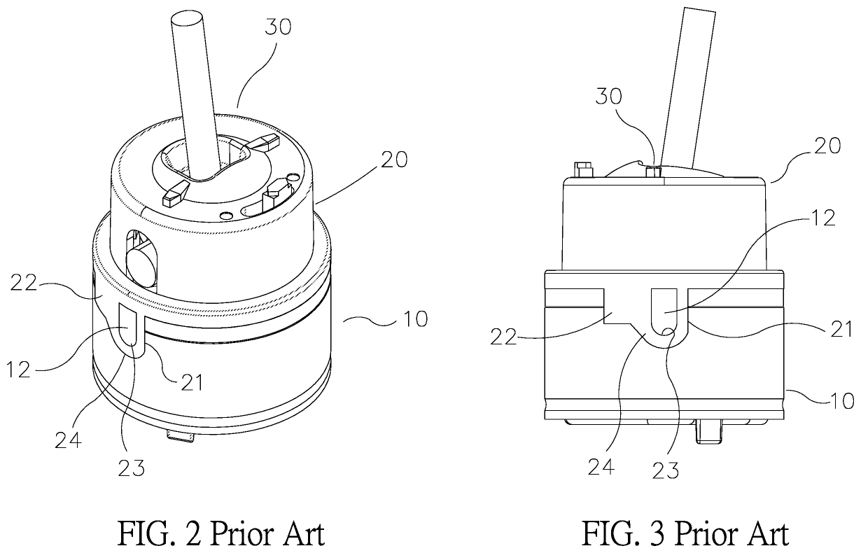

### DETAILED DESCRIPTION OF THE PREFERRED EMBODIMENTS

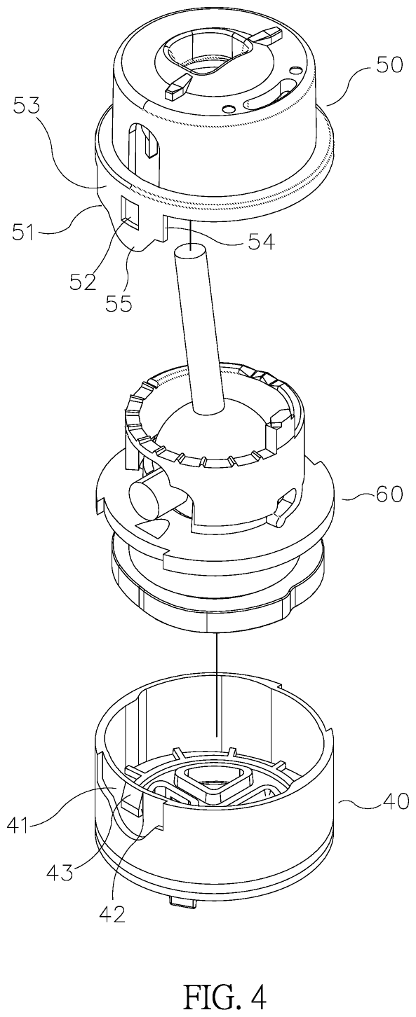

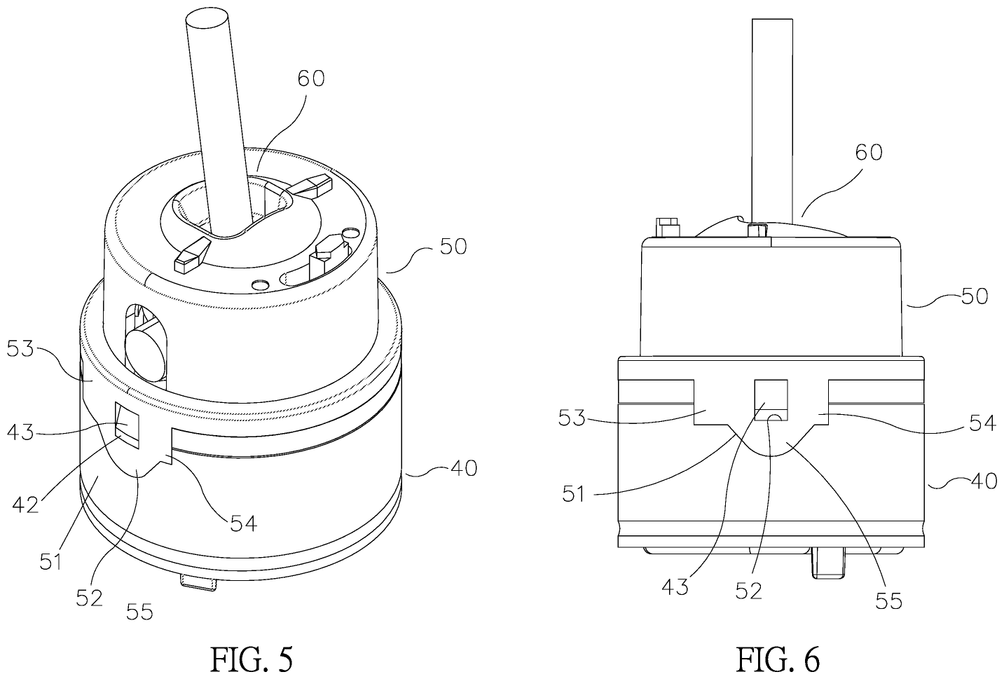

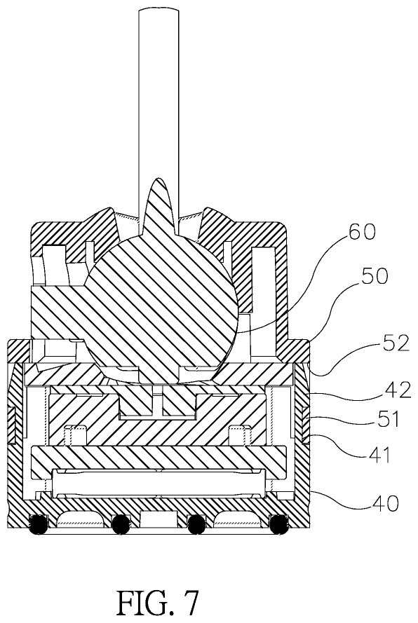

With reference to FIGS. 4-7, an external engagement structure of a housing for a water control valve according to a preferred embodiment of the present invention comprises: a holder 40 and a cover 50.

The holder 40 is configured to accommodate a water distribution sheet, an inlet valve disc, an outlet valve disc, a ball valve element, a fixing bolt, and an operation lever of a valve assembly 60 (since these components of the valve assembly 60 are well-known arts, further remarks are omitted) and is connected with the cover 50.

The cover 50 includes two opposite retainers 51 extending downward from a bottom thereof and formed in an arc shape so as to correspond to an outer wall of the holder 40, two first abutting portions 53 formed on two first sides of the two opposite retainers 51 respectively, and two second abutting portions 54 formed on two second sides of the two opposite retainers 51 respectively, two rectangular notches 52 formed on the two opposite retainers 51 respectively, wherein a respective one rectangular notch 52 is defined between a respective one first abutting portion 53 and a respective one second abutting portion 54 of a respective one retainer 51. The cover 50 further includes two arcuate contact portions 55 arranged on the two opposite retainers 51 respectively, wherein a respective one arcuate contact portion 55 of the respective one retainer 51 is located below the respective one rectangular notch 52.

The holder 40 includes two opposite arcuate grooves 41 defined on the outer wall thereof and corresponding to the two opposite retainers 51 of the cover 50 respectively, two locking protrusions 42 formed in the two opposite arcuate grooves 41 respectively, and two tilted guide faces 43 formed on two upper ends of the two locking protrusions 42 respectively and engaged into the two rectangular notches 52 respectively, wherein a size of a respective one locking protrusion 42 is equal to a size of the respective one rectangular notch 52.

In assembly, the valve assembly 60 is accommodated in the holder 40, and the cover 50 is covered on the holder 40, such that the two opposite retainers 51 of the cover 50 are engaged into the two opposite arcuate grooves 41 of the holder 40 respectively, the two rectangular notches 52 of the two opposite retainers 51 are retained with the two locking protrusions 42 of the two opposite arcuate grooves 41 respectively, and the two first abutting portions 53 and the two second abutting portions 54 of the two opposite retainers 51 contact with the holder 40 matingly to avoid a removal of the cover 50 and to connect the holder 40, the cover 50, and the valve assembly 60 firmly.

Thereby, the external engagement structure of the housing for the water control valve is applied to avoid a removal of the cover by ways of the two opposite retainers of the cover and the two opposite arcuate grooves of the holder, thus fixing the holder, the cover, and the valve assembly tightly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An external engagement structure of a housing for a water control valve, the water control valve including the housing and a valve assembly accommodated in the housing, and the housing comprising: a holder and a cover;
the holder being configured to accommodate the valve assembly, and the cover being configured to cover the holder, thus assembling the water control valve;
wherein the cover includes two opposite retainers extending downward from a bottom thereof and formed in an arc shape so as to correspond to an outer wall of the holder, two first abutting portions formed on two first sides of the two opposite retainers respectively, and two second abutting portions formed on two second sides of the two opposite retainers respectively, two rectangular notches formed on the two opposite retainers respectively, wherein a respective one rectangular notch is defined between a respective one first abutting portion and a respective one second abutting portion of a respective one retainer;
wherein a width of each of the two first abutting portions and a width of each of the two second abutting portions are both greater than a width of each of the two rectangular notches;
wherein the holder includes two opposite arcuate grooves defined on the outer wall thereof and corresponding to the two opposite retainers of the cover respectively, two locking protrusions formed in the two opposite arcuate grooves respectively, and two tilted guide faces formed on two upper ends of the two locking protrusions respectively and engaged into the two rectangular notches respectively, wherein a size of a respective one locking protrusion is equal to a size of a respective one rectangular notch; and
wherein when the cover is fixed to the holder, the two first abutting portions and the two second abutting portions of the two opposite retainers contact with the two opposite arcuate grooves of the holder matingly, and the two rectangular notches of the two opposite retainers are retained with the two locking protrusions of the two opposite arcuate grooves respectively, thus fixing the cover and the holder.
